(19) United States
(12) Patent Application Publication
(10) Pub. No.: US 2012/0294780 A1
(43) Pub. Date: Nov. 22, 2012

(54) DROP-IN NOZZLE

(75) Inventors: Mike Bailey, Gig Harbor, WA (US); Gary McLuen, Port Townsend, WA (US)

(73) Assignee: GeneForge, Inc., Redwood City, CA (US)

(21) Appl. No.: 13/474,547

(22) Filed: May 17, 2012

Related U.S. Application Data
(60) Provisional application No. 61/488,690, filed on May 20, 2011.

(51) Int. Cl. B01L 3/02; B21D 51/16

(52) U.S. Cl. 422/511; 29/890.09

(57) ABSTRACT

A drop-in nozzle system for use with a multi-well or multi-column synthesizer or other element distribution system. The drop-in nozzle system includes one or more insertable/removable and/or disposable nozzle inserts, a nozzle housing, an input tube and a fitting. The one or more nozzle inserts are able to vary in length and have ferrule assembly positioned at the top of the insert. As a result, the system enables a user to disconnect a fitting from a nozzle housing cavity thereby releasing the system's liquid-tight seal, replace the current nozzle insert with another insert, and then reconnect the fitting recreating the liquid-tight seal and enabling the system for operation with the new nozzle insert.

### RELATED APPLICATIONS

This patent application claims priority under 35 U.S.C. 119 (e) of the co-pending U.S. Provisional Patent Application Ser. No. 61/488,690, filed May 20, 2011, and entitled, “DROP-IN NOZZLE.” The Provisional Patent Application Ser. No. 61/488,690, filed May 20, 2011, and entitled, “DROP-IN NOZZLE” is also hereby incorporated by reference.

### FIELD OF THE INVENTION

The present invention relates to the field of nozzles. More particularly, the present invention relates to drop-in nozzles for dispense systems.

### BACKGROUND OF THE INVENTION

Currently, there is a large market for liquid dispensing units such as multi-well synthesizers which enable the performance of chemical assays at a much greater rate than manual assay methods. These synthesizers generally comprise dispensing tubes having ferrules coupled to the aspiration end that extend from the dispense valves/manifold all the way to the desired port and/or vial where the liquid is to be dispensed. FIG. 1 illustrates such a dispensing tube and bulkhead assembly 100. As shown in FIG. 1, a tubing assembly 100 includes a tube 102 received from a dispense valve (not shown) that first passes through a central channel of fitting 104, and then through the axial channel of ferrule 106. The tubing assembly 100 is able to be inserted into a housing 108 consisting of a cavity 110 having female threading and a bore wall 112 having a bore hole 114. When assembled, the tube 102 is inserted into the cavity 110 such that it abuts the bore wall 112 and communicates with the bore hole 114 while the ferrule 106 holds the tube 102 in place due to the force imparted by screwing the threaded fitting 104 into the cavity 110. The ferrule 106 is positioned at the aspiration end of the tube 102 to ensure that the tube 102 is unable to move and create dead volume between the end of the tube 102 and the bore wall 112. As a result, these systems do not have direction control, the control of droplets on the end of the tubing, and metered down nozzle approaches. Further, because a single tube is used between the dispense locations and the dispense valves, when a tip fouls, plugs or becomes damaged, the entire tubing must be replaced. Moreover, the positioning of the ferrule must be at the aspiration end of the tubing because otherwise the likelihood of dead volume would increase. Additionally, when using the tubing of these systems, the ability of the valves to theoretically produce minimal amounts of reactant is not realized. This is because the internal volume of the tubing leading from the dispense valves acts as a spring or capacitor such that even if the valves are calibrated to only open for 30 milliseconds the fluidic dispensing cannot be accurately controlled. For example, there is usually a droplet of liquid remaining on the end of the tubing which prevents the desired minimal amount of reactant to be dispensed. In total, this results in added cost as well as inconvenience in having to disengage the tubing from the dispense valves and the dispense location as well as all other components in between.

### SUMMARY OF THE INVENTION

A drop-in nozzle system for use with a multi-well synthesizer or other element distribution system. The drop-in nozzle system comprises one or more insertable/removable and/or disposable nozzle inserts, a nozzle housing, an input tube and a fitting. The one or more nozzle inserts are able to vary in length and have ferrule assembly positioned at the top of the insert. As a result, instead of needing to replace an entire section of tubing, the nozzle inserts are able to be exchangeably inserted/removed into a desired nozzle housing for distributing liquid or other elements in, for example, a multi-well synthesizer. Specifically, the system enables a user to disconnect a fitting from a nozzle housing cavity thereby releasing the system's liquid-tight seal, replace the current nozzle insert with another insert, and then reconnect the fitting recreating the liquid-tight seal and enabling the system for operation with the new nozzle insert. As a result, a user is able to easily dispose of damaged nozzles and/or replace nozzles with nozzle inserts of varying length, inner tubing diameters and/or tubing material as desired or needed without removing or replacing the remainder of the tubing. This concept can also be used to retrofit exiting synthesizers to allow for smaller, more accurate flow rates, breathing new life into previously considered obsolete instruments, specifically synthesizers.

A first aspect of the application is directed to a drop-in nozzle system for controlled aspiration of one or more reactants. The system comprises a drop-in nozzle including a nozzle tube having an inlet and an outlet, an input tube for detachably coupling a reactant source to the inlet of the nozzle tube, a nozzle housing for receiving the drop-in nozzle and an outlet end of the input tube and a fitting for detachably coupling the outlet end of the input tube to the inlet of the drop-in nozzle within the nozzle housing such that the reactants are able to aspirated from the input tube to the outlet of the drop-in nozzle. In some embodiments, the drop-in nozzle comprises a nozzle ferrule surrounding the nozzle tube and positioned at the inlet of the nozzle tube. In some embodiments, the nozzle ferrule is configured to compress the perimeter of the nozzle tube when pressed against the walls of the nozzle housing by the fitting. In some embodiments, the outlet of the drop-in nozzle is angled such that the direction of the outlet is different than the direction of the remainder of the nozzle tube. In some embodiments, the inner surface, the outer surface or both of the nozzle tube are coated with a protective material that insulates the coated surfaces of the nozzle tube from the reactant. In some embodiments, the system further comprises a linearly or rotary actuated synthesizer having one or more pumps, vials and reactant tanks, wherein the pumps are configured to selectively pump reactant from the reactant tanks through the input tube and the nozzle insert into one or more of the vials. In some embodiments, the nozzle tube comprises an inner diameter that is different than the inner diameter of the input tube. In some embodiments, the nozzle tube is formed by a material that is different than the material that forms the input tube. In some embodiments, the insert nozzle is modular such that the drop-in nozzle is able to be replaced within the system with one or more different drop-in nozzles having different nozzle tube lengths, inner diameters and/or compositions. In some embodiments, the system further comprises an additional nozzle housing, an additional fitting and an additional input tube, wherein the additional nozzle housing has a channel that is detachably coupled with the additional input tube by the additional fitting and is in communication with the outer surface of the nozzle tube within the nozzle housing. In some embodiments, the input tube comprises an input tube ferrule positioned around the outlet end of the input tube for enabling the fitting to couple the outlet end of the input tube to the inlet of the drop-in nozzle.

A second aspect of the application is directed to a drop-in nozzle for controlled aspiration of one or more reactants in a drop-in nozzle system. The drop-in nozzle comprises a nozzle tube having an inlet and an outlet and a nozzle ferrule surrounding the nozzle tube and positioned at the inlet of the nozzle tube, wherein the nozzle ferrule is configured to compress the perimeter of the nozzle tube when pressed against the walls of a nozzle housing by a fitting. In some embodiments, the outlet of the drop-in nozzle is angled such that the direction of the outlet is different than the direction of the remainder of the nozzle tube. In some embodiments, the inner surface, the outer surface or both of the nozzle tube are coated with a protective material that insulates the coated surfaces of the nozzle tube from the reactant. In some embodiments, the nozzle tube comprises an inner diameter that is less than 0.030 inches.

A third aspect of the application is directed to a method of controlling the aspiration of one or more reactants with a drop-in nozzle system. The method comprises selecting a selected drop-in nozzle having nozzle tube with an inlet and an outlet from a plurality of drop-in nozzles having different properties, inserting the selected drop-in nozzle into a nozzle housing and securing an outlet end of an input tube to the inlet of the selected drop-in nozzle within the nozzle housing by engaging a fitting with the nozzle housing, wherein the securing enables the reactants to be aspirated from the outlet of the drop-in nozzle via the input tube. In some embodiments, the properties comprise nozzle tube length, drop-in nozzle composition and nozzle tube inner diameter. In some embodiments, the properties of the selected drop-in nozzle are selected based on the reactant to be aspirated by the system. In some embodiments, the method further comprises replacing the selected drop-in nozzle secured within the nozzle housing by disengaging the fitting from the nozzle housing, separating the outlet end of the input tube from the inlet of the selected drop-in nozzle, removing the selected drop-in nozzle from the nozzle housing, selecting a replacement drop-in nozzle having nozzle tube with an inlet and an outlet from the plurality of drop-in nozzles having different properties, inserting the selected drop-in nozzle into a nozzle housing and securing the outlet end of the input tube to the inlet of the replacement drop-in nozzle within the nozzle housing by re-engaging the fitting with the nozzle housing. In some embodiments, the drop-in nozzle comprises a nozzle ferrule surrounding the nozzle tube and positioned at the inlet of the nozzle tube. In some embodiments, the nozzle ferrule compresses the perimeter of the nozzle tube when the fitting engages the nozzle housing. In some embodiments, the outlet of the drop-in nozzle is angled such that the direction of the outlet is different than the direction of the remainder of the nozzle tube. In some embodiments, the inner surface, the outer surface or both of the nozzle tube are coated with a protective material that insulates the coated surfaces of the nozzle tube from the reactant. In some embodiments, the method further comprises aspirating the reactants from the outlet of the selected drop-in nozzle using a linearly or rotary actuated synthesizer having one or more pumps, vials and reactant tanks by selectively pumping reactant from the reactant tanks through the input tube and the nozzle insert into one or more of the vials. In some embodiments, the nozzle tube comprises an inner diameter that is different than the inner diameter of the input tube. In some embodiments, the nozzle tube is formed by a material that is different than the material that forms the input tube. In some embodiments, the method further comprises rinsing the outer surface of the nozzle tube within the housing an additional nozzle housing, an additional fitting and an additional input tube, wherein the additional nozzle housing has a channel that is detachably coupled with the additional input tube by the additional fitting and is in communication with the outer surface of the nozzle tube within the nozzle housing. In some embodiments, the securing comprises pressing an input tube ferrule positioned around the outlet end of the input tube against the inlet of the nozzle tube with the fitting forming an air-tight seal.

A fourth aspect of the application is directed to an input tube for controlled aspiration of one or more reactants from a reactant tank in a drop-in nozzle synthesizing system, the input tube comprising a tube portion having an inlet end configured to couple with the reactant tank and an outlet end configured to detachably couple to a drop-in nozzle and a ferrule ring coupled around the outer perimeter of outlet end of the tube portion for enabling a fitting to couple the outlet end of the tube portion to the inlet of a drop-in nozzle.

### BRIEF DESCRIPTION OF THE DRAWINGS

FIG. 1 illustrates a cross section view of a prior art tubing assembly.

FIG. 2A illustrates a cross sectional view of a drop-in nozzle system according to some embodiments.

FIG. 2B illustrates a cross sectional view of another drop-in nozzle system according to according to some embodiments.

FIG. 3A illustrates a cross sectional view of a nozzle insert according to some embodiments.

FIG. 3B illustrates a cross sectional view of a nozzle insert according to some embodiments.

FIGS. 4A and 4B illustrate cross sectional views of nozzle housings according to some embodiments.

FIG. 5 illustrates a flow chart of a method of using the drop-in nozzle system according to some embodiments.

### DETAILED DESCRIPTION OF THE PRESENT INVENTION

While the present invention will be described with reference to several specific embodiments, the description is illustrative of the present invention and is not to be construed as limiting the invention. Various modifications to the present invention can be made without departing from the scope and spirit of the present invention. For the sake of clarity and a better understanding of the present invention, common components share common reference numerals throughout various figures.

The drop-in nozzle system of the present application is for providing modular, disposable and adjustable nozzles for use with a synthesizer, such as multi-well, solenoid valve, electro-spray, linear actuation and/or rotary actuation synthesizers, or other liquid distribution device (not shown). The drop-in nozzle system is designed for enabling a user to easily exchange and/or remove nozzle inserts as desired, wherein the nozzle inserts provide the needed liquid-tight sealing performance required for synthesis operations. Unlike previous systems, the drop-in nozzle system separates the nozzle insert from the input tube thus avoiding the need to replace entire input tubes as well as enabling the adjustment of the nozzle characteristics such as nozzle tube length, nozzle material and/or nozzle tube inner diameter. This ability to select nozzle characteristics allows greater control and reproducibility of accurate clean aspiration of liquid. This system is able to be used to retrofit existing synthesizers to allow for smaller, more accurate, flow rates thereby breathing new life into previously considered obsolete instruments. Although, the drop-in nozzle system and nozzle inserts are particularly suited for a multi-well synthesizer, it is understood that the system is also able to be used in other applications using nozzles for dispensing liquids. Further, although the drop-in nozzle system is described below in relation to a single nozzle insert and nozzle housing, it is understood that the system is able to comprise a plurality of inserts for use with an array of nozzle housings. Thus, the present application should not be limited to these specific examples disclosed herein.

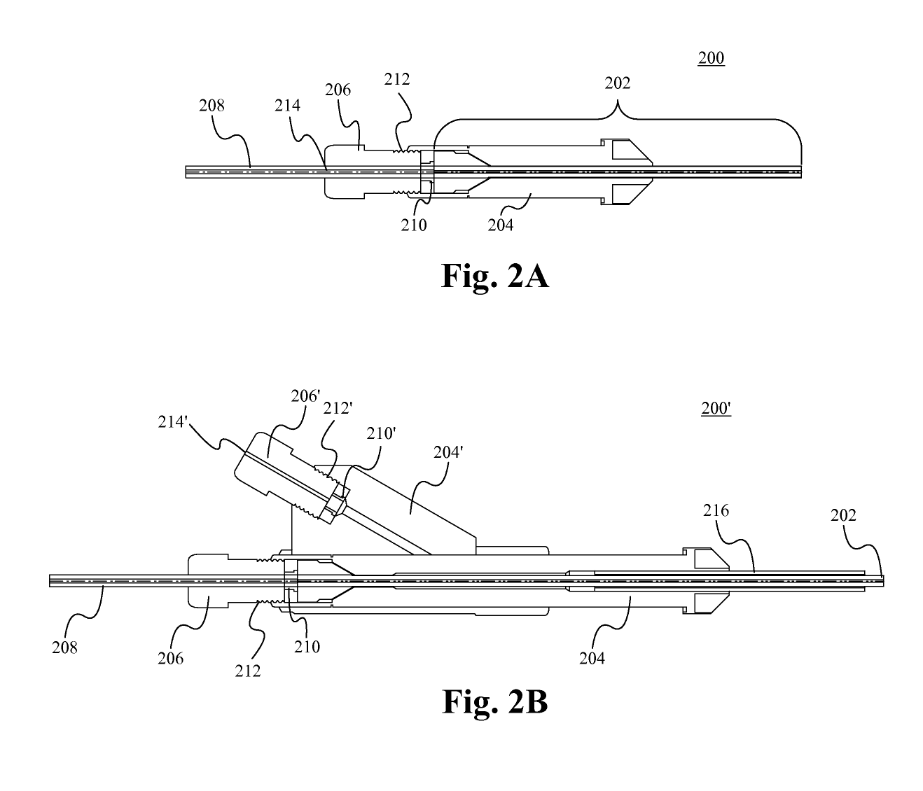

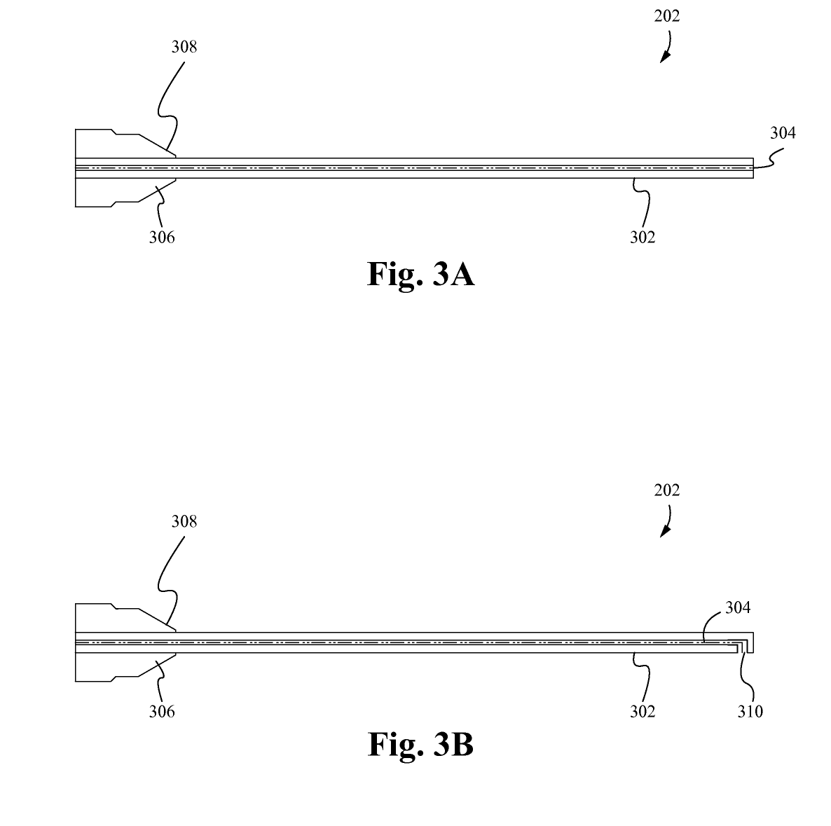

FIG. 2A illustrates a cross sectional view of a drop-in nozzle system 200 according to some embodiments. The drop-in nozzle system 200 comprises a nozzle insert 202, a nozzle housing 204, a fitting 206 and an input tubing 208. In some embodiments, the input tubing 208 comprises a tubing ferrule assembly 210 that enables the fitting 206 to press the input tubing 208 against the back or broad portion of a nozzle ferrule assembly 306 (see FIG. 3) of the insert nozzle 202. The tubing ferrule assembly 210 is able to be permanently or releasably coupled to the input tube 208. The nozzle insert 202 is sized such that it is able to be selectively inserted into a cavity 402 and channel 408 of the nozzle housing 204. In particular, the nozzle tube 302 is sized such that the nozzle tube 302 fits within the channel 408 and the nozzle ferrule assembly 306 is sized such that it fits within the cavity 402. The input tubing 208 is sized such that it is able to be selectively inserted though an axial channel 214 of the fitting 206.

As a result, the input tubing 208 and back portion of the nozzle ferrule assembly 306 nozzle insert 202 are able to be releasably coupled together via pressure applied by the fitting 206. In particular, the fitting 206 comprises threading 212 that corresponds to threading 412 within the cavity of the housing 204 such that when a user screws the fitting 206 into the cavity 402, the force causes a liquid-tight seal to be formed between the input tubing 208 (including the tubing ferrule 210) and the nozzle insert 202, as well as between a ferrule assembly 306 of the nozzle insert 202 and the nozzle housing 204. Alternatively, other coupling elements are able to be used to releasably form a liquid-tight seal between the input tubing 208, the nozzle insert 202 and the housing 204 as are well known in the art. When sealed, the channel of the input tubing 208 is positioned such that the channel is in alignment with the channel of the nozzle insert. As a result, the drop-in nozzle system 200 enables liquid, gas and/or other materials to be transmitted through the input tubing 208, the nozzle insert 202 and the nozzle housing 204 without leaking into the nozzle housing 204 or other undesired areas. In some embodiments, the nozzle system 200 is used in conjunction with one or more additional nozzle systems 200 (such as but not limited to drop-in nozzle system 200′ described below) to provide a set of nozzles for a synthesizing or other element distribution device (not shown). Alternatively, the nozzle system 200 is able to be utilized individually.

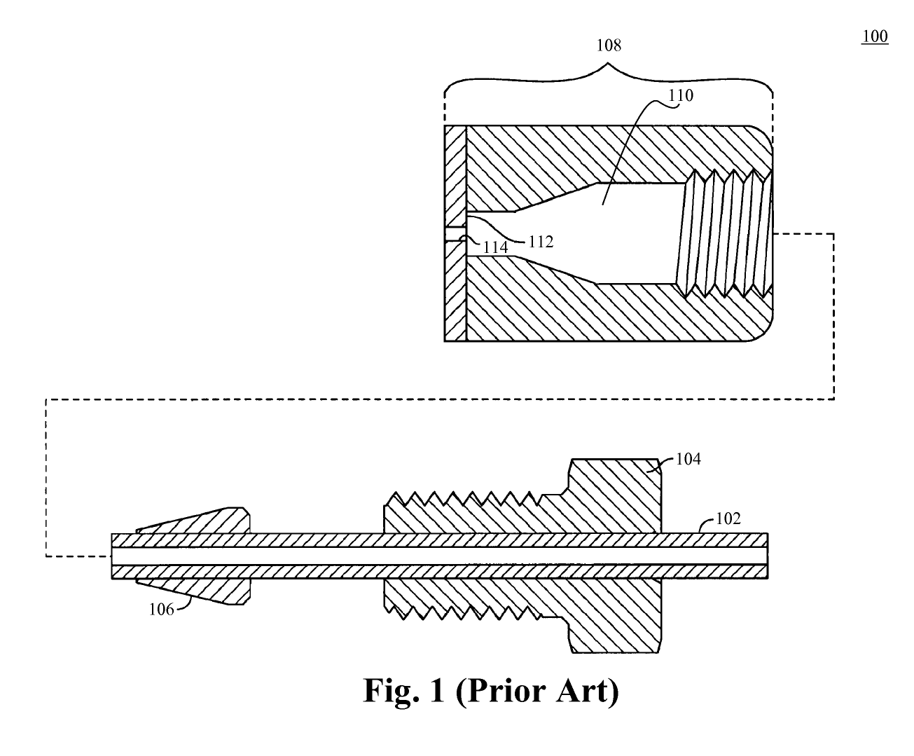

FIG. 2B illustrates a cross sectional view of another embodiment of a drop-in nozzle system 200′. The system 200′ shown in FIG. 1B is substantially similar to the system 200 shown in FIG. 1A except the differences described herein. In particular, as shown in FIG. 1B, the drop-in nozzle system 200′ comprises an additional nozzle housing 204′, an additional fitting 206′, and a tube shield 216. Although as shown the system 200′ only comprises a single additional housing 204′ and fitting 206′, a plurality of additional housings 204′ and/or fittings 206′ are able to be incorporated in the system 200′. Similar to the fitting 206 described in relation to FIG. 2A, the additional fitting 206′ comprises a channel 214′ for receiving an input tube (not shown) and threading 212′ for enabling a user to screw the fitting 206′ into the cavity 402 of the additional housing 204′ thereby applying force to the additional tubing ferrule 210′ creating a liquid-tight seal. The channel 214′ continues through the additional housing 204′ and is in communication with the cavity 302 such that liquid or gas dispensed through the tubing and channel 214′ is able to contact the outer diameter of the nozzle insert 202 in order to flush or wash the nozzle insert 202 and prevent undesirably chemical reactions from occurring with the nozzle insert 202. The tube shield 216 is coupled to the housing 204 and extends out from the tip of the housing 204 such that the tube shield 216 is able to protect, support and/or guide the portion of the tube insert 202 that extends out of the housing 204. As a result, the tubing insert 202 is able to better be positioned/directed as desired for operation with a synthesizer or other element distribution system. Similar to above, the nozzle system 200′ is able to be used in conjunction with one or more additional nozzle systems 200′ (such as but not limited to drop-in nozzle system 200) to provide a set of nozzles for a synthesizing or other element distribution device (not shown). Alternatively, the drop-in nozzle system 200′ is able to be utilized individually.

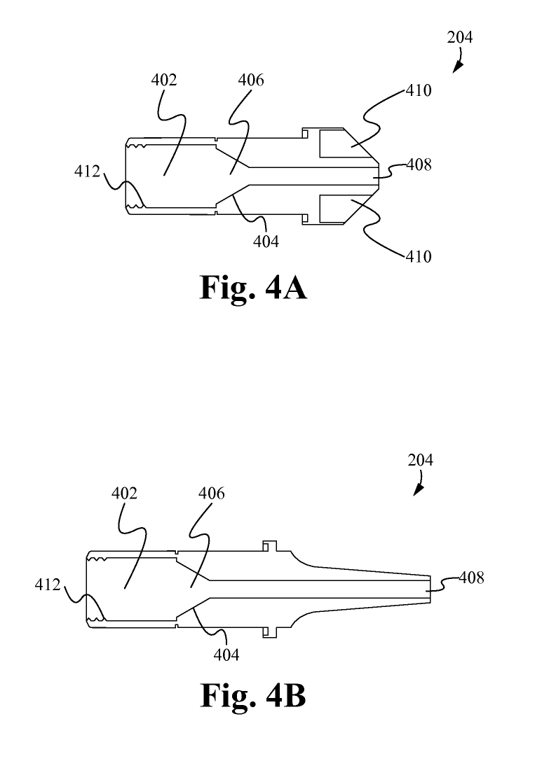

FIG. 3A illustrates a cross sectional view of a nozzle insert 202 according to some embodiments. The nozzle insert 202 comprises a nozzle tube 302 which creates the nozzle channel 304 and the nozzle ferrule assembly 306. In some embodiments, the nozzle insert 202 is formed by PEEK. Alternatively, the nozzle insert 202 is able to be formed of one or more of PEEK (polyether ether ketone), PEEKSil (PEEK and fused silica composite), stainless steel, fused silica tubing and/or other materials as are well known in the art. In some embodiments, the nozzle insert 202 comprises wetted material within the nozzle comprising fused silica glass. Use of this fused silica glass provides the benefit of protecting the nozzle insert 202 from the dispensed liquids as the silica glass is often inert to chemistries used in chemical synthesis. Alternatively, other material is able to form or be coated onto the inner, outer and/or other portions of the nozzle tube 302 or nozzle insert 202 in order to effectuate a change in the cohesive force or flow characteristics of the reactant or interaction between the nozzle 202 and the reactant moving through the nozzle 202 as are well known in the art. In some embodiments, different materials are able to be used to coat the inner surface and outer surface of the nozzle tube 302. Alternatively, the same material is able to be used to coat both the inner and outer surface of the nozzle tube 302. The length, material and/or inner tube diameter of the nozzle tube 302 is able to be varied based on the requirements of the application using the nozzle insert 202. As a result, nozzle inserts 202 of varying tube length, composition, outer tube diameter and/or inner tube diameter are able to be selectively exchanged in one or more nozzle housings 204 as required/desired. This provides the advantage of allowing a user to selectively adjust the metering of a dispensed liquid via a nozzle insert 202 with a different inner diameter nozzle tube 302. For example, unlike the previously where because the nozzle 202 was a part of the input tube the nozzle 202 necessarily had the same inner diameter, length and composition as the input tube, a user is able to choose a nozzle 202 with varying composition, length and/or a smaller or larger inner diameter nozzle tube 302 than the input tube in order to increase or decrease the rate, accuracy and other characteristics of how the liquid is dispensed. In particular, the inner diameter of the nozzle tube 302 is able to comprise between 25 μm (0.001″) and 1000 μm (0.040″). Alternatively, the inner diameter of the nozzle tube 302 is able to comprise other diameters. Additionally, in some embodiments the nozzle tube 302 comprises an outer sleeve in order to attain an outer diameter that fits within the housing channel 408 (see FIG. 4).

As shown in FIG. 3A, the nozzle ferrule assembly 306 comprises an angled or conic portion 308. Alternatively, the nozzle ferrule assembly 306 is able to be a flat bottom ferrule similar to the tube ferrule assembly 210 or other type of ferrule able to accommodate liquid-tight sealing for a swept volume connection. Alternatively, any type of ferrule is able to be used as are well known in the art. The nozzle ferrule assembly 306 swages onto the nozzle tube 302 and liquid-tightly seals to the tube ferrule assembly 210 of the insert tube 208 when inserted into the nozzle housing 204 and pressed against the tube ferrule assembly 210 by the fitting 206. The nozzle ferrule assembly 306 is positioned at the top or portal end of the nozzle tube 302 such that the back of the ferrule assembly 306 is flush or even with the top of the nozzle tube 302. Specifically, as shown in the embodiment of FIG. 3A, the narrow side of the conic portion 308 of the ferrule assembly 306 is proximate the bottom or aspiration end of the nozzle tube 302 and the broad side of the conic portion 308 is substantially flush or even with the top of the nozzle tube 302. As a result of this positioning of the ferrule assembly 306, the nozzle insert 202 is able to form a liquid and/or gas tight seal with the input tube 208 (via the tube ferrule assembly 210). In some embodiments, this seal between the nozzle ferrule assembly 306 and the tube ferrule assembly 210 is a butt connection. Alternatively, other types of connections creating liquid-tight seals are able to be used as are well known in the art. This provides the benefit of reducing or eliminating the problem of dead volume because the ferrule to ferrule seal eliminates the need for an input tube 208 to be precisely sized such that it presses against a bore wall 112 (see FIG. 1). Further, this enables the nozzle tube 302 to extend outside of the housing 204 and therefore vary in length providing greater liquid dispersion directional control.

FIG. 3B illustrates a cross sectional view of a nozzle insert 202 according to an alternate embodiment. The nozzle insert 202 shown in FIG. 3B is substantially similar to the insert 202 shown in FIG. 3A except the differences described herein. In particular, the nozzle insert 202 of FIG. 3B comprises a down-turned opening 310 of the nozzle channel 304 that causes the reactant to exit the channel 304 in different direction than the majority of the channel. As a result, the change in direction created by the down-turned opening 310 (along with minimal nozzle tube 302 inner diameter) minimizes the size of droplets that hang at the end of the nozzle tube 302 thereby increasing the accuracy of the dispense process.

FIGS. 4A and 4B illustrate a cross sectional view of nozzle housings 204 according to some embodiments. The nozzle housings 204 comprise a housing cavity 402 and a housing channel 408 that are able to receive and house a nozzle insert 202. Specifically, the housing channel 408 does not require a bore wall 112 and thus is able to receive the nozzle tube 302 such that the tube 302 is able to project out the end of the housings 204. Thus, unlike previous systems, the housings 204 are advantageous as they enable the nozzle inserts 202 to vary in length and direction. Further, the housing cavity 402 comprises a conical portion 406 with angled walls 404 that is able to receive the ferrule assembly 306 of the nozzle insert 202 and apply sealing and swaging pressure (via the screwing of a fitting 206 into cavity wall threading 412) to the ferrule assembly 306. Alternatively, the cavity 402 is able to comprise other shapes capable of receiving the nozzle inserts 202, tubing ferrule apparatus 210 and/or fitting 206. In some embodiments, a liquid-tight seal is able to be created between the housing walls 404 and the conic portion 308 of the ferrule assembly 306 to prevent leaking during the distribution of material through the nozzle tubing 302. In some embodiments, the nozzle housings 204 further comprise one or more coupling elements 410 that enable the housings 204 to releasably couple to a synthesizer or other element distribution device.

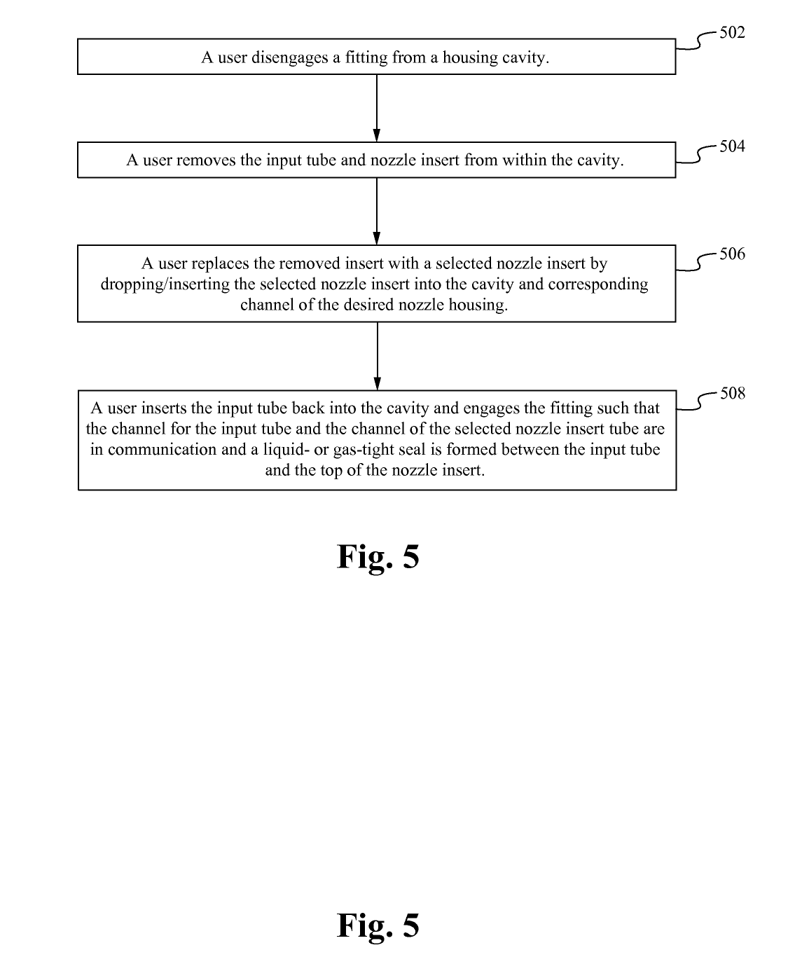

The operation of the drop-in nozzle system 200, 200′ will now be discussed in conjunction with the flow chart shown in FIG. 5. Specifically, a user disengages the fitting 206 from a housing cavity 402 at the step 502. In some embodiments, the fitting 106 is disengaged by unscrewing the fitting 106 from the threads 412 of the cavity 402. Alternatively, the fitting 206 is able to be disengaged via an alternate form of disengagement as are well known in the art. A user removes the input tube 208 and nozzle insert 202 from within the cavity 402 at the step 504. In some embodiments, the insert 202 is removed based on the tube 302 length. Alternatively, the insert 202 is able to be removed based on one or more of nozzle tube length, nozzle tube inner diameter, nozzle composition material, nozzle damage or defective operation, and/or other nozzle characteristics as are well known in the art. A user replaces the removed insert 202 with a selected nozzle insert 202 by dropping/inserting the selected nozzle insert 202 into the cavity 402 of the nozzle housing 204 at the step 506. In some embodiments, the selection of the nozzle insert 202 to be inserted is based on its tube length, tube inner diameter and/or tube composition. Alternatively, the selection is able to be based on other characteristics of the selected nozzle insert 202 as are well known in the art. A user inserts the input tube 208 into the cavity 402 and engages the fitting 206 such that the channel of the input tube 208 and the channel 304 of the selected nozzle tube 302 are in alignment and an liquid- or gas-tight seal is formed between the input tube 208 and the top of the nozzle insert 202 at the step 508. As a result, the drop-in nozzle system 200, 200′ provides the advantage of allowing a user to easily replace nozzles based on defective operation, old age or in order to exchange the current nozzle insert 202 for another nozzle insert 202 having a different tube length, inner diameter or composition without removing the entire input tubing 208. Further, because of the modular or exchangeable design of the nozzle inserts 202, the system 200, 200′ enables a user to use any selected nozzle insert 202 with any desired housing 204. Additionally, it should be noted that although the above method is described in relation to a user, it is understood that the actions are able to be taken automatically by a device such as a synthesizer or a combination thereof.

The present application has numerous advantages. Specifically, the present application provides the advantage of being able to selectively remove damaged or undesired nozzles without removing the entire input tubing, rather only requiring the disengaging of a fitting, the replacement of the current nozzle and the re-engagement of the fitting. Further, it provides the benefit of allowing the dispensing nozzles to be exchanged based on tube length, composition, inner diameter and/or other characteristics in order to meet the needs of the current application. Moreover, these characteristics allow minimal amounts of reactant to be dispensed reproducibly with more precise control of velocity, stream size and dispense time such that there is less splashing and dripping therefore less potential for cross contamination. Indeed, these benefits are able to be obtained even when operating with outdated or pre-existing synthesizer technology. Accordingly, the present application provides numerous advantages over the prior art.

The present application has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention. Specifically, it will be apparent to one of ordinary skill in the art that the device of the present application could be implemented in several different ways and the embodiments disclosed above are only exemplary of the preferred embodiment and the alternate embodiments of the invention and is in no way a limitation.

What is claimed is:

1. A drop-in nozzle system for controlled aspiration of one or more reactants, the system comprising:
a. a drop-in nozzle including a nozzle tube having an inlet and an outlet;
b. an input tube for detachably coupling a reactant source to the inlet of the nozzle tube;
c. a nozzle housing for receiving the drop-in nozzle and an outlet end of the input tube; and
d. a fitting for detachably coupling the outlet end of the input tube to the inlet of the drop-in nozzle within the nozzle housing such that the reactants are able to aspirated from the input tube to the outlet of the drop-in nozzle.

2. The system of claim 1 wherein the drop-in nozzle comprises a nozzle ferrule surrounding the nozzle tube and positioned at the inlet of the nozzle tube.

3. The system of claim 2 wherein the nozzle ferrule is configured to compress the perimeter of the nozzle tube when pressed against the walls of the nozzle housing by the fitting.

4. The system of claim 1 wherein the outlet of the drop-in nozzle is angled such that the direction of the outlet is different than the direction of the remainder of the nozzle tube.

5. The system of claim 1 wherein the inner surface, the outer surface or both of the nozzle tube are coated with a protective material that insulates the coated surfaces of the nozzle tube from the reactant.

6. The system of claim 1 further comprising a linearly or rotary actuated synthesizer having one or more pumps, vials and reactant tanks, wherein the pumps are configured to selectively pump reactant from the reactant tanks through the input tube and the nozzle insert into one or more of the vials.

7. The system of claim 1 wherein the nozzle tube comprises an inner diameter that is different than the inner diameter of the input tube.

8. The system of claim 1 wherein the nozzle tube is formed by a material that is different than the material that forms the input tube.

9. The system of claim 1 wherein the insert nozzle is modular such that the drop-in nozzle is able to be replaced within the system with one or more different drop-in nozzles having different nozzle tube lengths, inner diameters and/or compositions.

10. The system of claim 1 further comprising an additional nozzle housing, an additional fitting and an additional input tube, wherein the additional nozzle housing has a channel that is detachably coupled with the additional input tube by the additional fitting and is in communication with the outer surface of the nozzle tube within the nozzle housing.

11. The system of claim 1 wherein the input tube comprises an input tube ferrule positioned around the outlet end of the input tube for enabling the fitting to couple the outlet end of the input tube to the inlet of the drop-in nozzle.

12. A drop-in nozzle for controlled aspiration of one or more reactants in a drop-in nozzle system, the drop-in nozzle comprising:
a. a nozzle tube having an inlet and an outlet; and
b. a nozzle ferrule surrounding the nozzle tube and positioned at the inlet of the nozzle tube;
wherein the nozzle ferrule is configured to compress the perimeter of the nozzle tube when pressed against the walls of a nozzle housing by a fitting.

13. The nozzle of claim 12 wherein the outlet of the drop-in nozzle is angled such that the direction of the outlet is different than the direction of the remainder of the nozzle tube.

14. The nozzle of claim 12 wherein the inner surface, the outer surface or both of the nozzle tube are coated with a protective material that insulates the coated surfaces of the nozzle tube from the reactant.

15. The nozzle of claim 12 wherein the nozzle tube comprises an inner diameter that is less than 0.030 inches.

16. A method of controlling the aspiration of one or more reactants with a drop-in nozzle system, the method comprising:
a. selecting a selected drop-in nozzle having nozzle tube with an inlet and an outlet from a plurality of drop-in nozzles having different properties;
b. inserting the selected drop-in nozzle into a nozzle housing; and
c. securing an outlet end of an input tube to the inlet of the selected drop-in nozzle within the nozzle housing by engaging a fitting with the nozzle housing;
wherein the securing enables the reactants to be aspirated from the outlet of the drop-in nozzle via the input tube.

17. The method of claim 16 wherein the properties comprise nozzle tube length, drop-in nozzle composition and nozzle tube inner diameter.

18. The method of claim 17 wherein the properties of the selected drop-in nozzle are selected based on the reactant to be aspirated by the system.

19. The method of claim 16 further comprising replacing the selected drop-in nozzle secured within the nozzle housing by:
a. disengaging the fitting from the nozzle housing;
b. separating the outlet end of the input tube from the inlet of the selected drop-in nozzle;
c. removing the selected drop-in nozzle from the nozzle housing;
d. selecting a replacement drop-in nozzle having nozzle tube with an inlet and an outlet from the plurality of drop-in nozzles having different properties;
e. inserting the selected drop-in nozzle into a nozzle housing; and
f. securing the outlet end of the input tube to the inlet of the replacement drop-in nozzle within the nozzle housing by re-engaging the fitting with the nozzle housing.

20. The method of claim 16 wherein the drop-in nozzle comprises a nozzle ferrule surrounding the nozzle tube and positioned at the inlet of the nozzle tube.

21. The method of claim 20 wherein the nozzle ferrule is compresses the perimeter of the nozzle tube when the fitting engages the nozzle housing.

22. The method of claim 16 wherein the outlet of the drop-in nozzle is angled such that the direction of the outlet is different than the direction of the remainder of the nozzle tube.

23. The method of claim 16 wherein the inner surface, the outer surface or both of the nozzle tube are coated with a protective material that insulates the coated surfaces of the nozzle tube from the reactant.

24. The method of claim 16 further comprising aspirating the reactants from the outlet of the selected drop-in nozzle using a linearly or rotary actuated synthesizer having one or more pumps, vials and reactant tanks by selectively pumping reactant from the reactant tanks through the input tube and the nozzle insert into one or more of the vials.

25. The method of claim 16 wherein the nozzle tube comprises an inner diameter that is different than the inner diameter of the input tube.

26. The method of claim 16 wherein the nozzle tube is formed by a material that is different than the material that forms the input tube.

27. The method of claim 16 further comprising rinsing the outer surface of the nozzle tube within the housing an additional nozzle housing, an additional fitting and an additional input tube, wherein the additional nozzle housing has a channel that is detachably coupled with the additional input tube by the additional fitting and is in communication with the outer surface of the nozzle tube within the nozzle housing.

28. The method of claim 16 wherein the securing comprises pressing an input tube ferrule positioned around the outlet end of the input tube against the inlet of the nozzle tube with the fitting forming an air-tight seal.

29. An input tube for controlled aspiration of one or more reactants from a reactant tank in a drop-in nozzle synthesizing system, the input tube comprising a tube portion having an inlet end configured to couple with the reactant tank and an outlet end configured to detachably couple to a drop-in nozzle and a ferrule ring coupled around the outer perimeter of outlet end of the tube portion for enabling a fitting to couple the outlet end of the tube portion to the inlet of a drop-in nozzle.
